(19) United States
(12) Patent Application Publication
(10) Pub. No.: US 2014/0314605 A1
(43) Pub. Date: Oct. 23, 2014

(54) VALVE APPARATUS AND HIGH PRESSURE PUMP HAVING THE SAME

(71) Applicants: DENSO CORPORATION, Kariya-city (JP); NIPPON SOKEN, INC., Nishio-city (JP)

(72) Inventors: Tatsuro KOGA, Chita-gun (JP); Ichiki TERASHIMA, Nukata-gun (JP); Toshihide ONO, Chita-gun (JP); Seiji TANIZAWA, Aichi-gun (JP); Takehiko KATO, Nukata-gun (JP); Masatoshi KUROYANAGI, Kariya-city (JP); Shinobu OIKAWA, Kariya-city (JP); Noriya MATSUMOTO, Okazaki-city (JP)

(73) Assignees: DENSO CORPORATION, Kariya-city (JP); NIPPON SOKEN, INC., Nishio-city (JP)

(21) Appl. No.: 14/254,485

(22) Filed: Apr. 16, 2014

(30) Foreign Application Priority Data
Apr. 18, 2013 (JP) 2013-87281
Oct. 16, 2013 (JP) 2013-215498

(51) Int. Cl. F02M 37/00; F04B 53/10

(52) U.S. Cl. CPC F02M 37/0023; F04B 53/10
USPC 417/568; 251/325

(57) ABSTRACT

A common seat portion includes discharge passages that communicate between a first valve chamber and a second valve chamber when a discharge valve member is lifted away from the common seat portion. The common seat portion also includes a relief passage that extends substantially parallel to the discharge passages and communicates between the first valve chamber and the second valve chamber when a relief valve member is lifted away from the common seat portion.

### CROSS REFERENCE TO RELATED APPLICATION

This application is based on and incorporates herein by reference Japanese Patent Application No. 2013-87281 filed on Apr. 18, 2013 and Japanese Patent Application No. 2013-215498 filed on Oct. 16, 2013.

### TECHNICAL FIELD

The present disclosure relates to a valve apparatus and a high pressure pump having the same.

### BACKGROUND

A known high pressure pump pressurizes fuel received from a fuel tank and feeds the pressurized fuel to a high pressure passage connected to fuel injection valves. The high pressure pump includes a plunger, a cylinder, a fuel intake arrangement, and a fuel discharge arrangement. The cylinder includes a pressurizing chamber that reciprocatably receives the plunger and pressurizes the fuel. The fuel intake arrangement supplies the fuel to the pressurizing chamber. The fuel discharge arrangement discharges the fuel from the pressurizing chamber to the high pressure passage. The fuel discharge arrangement includes a valve apparatus of a normally closed type. When the pressure of the fuel in the high pressure chamber is increased, the valve apparatus opens to communicate the pressurizing chamber to the high pressure passage. JP2012-184745A (corresponding to US2012/0227711A1) discloses a valve apparatus, which includes a valve seat portion. The valve seat portion has a discharge passage and a relief passage. The discharge passage conducts the fuel from the pressurizing chamber to the high pressure passage, and the relief passage conducts the fuel from the high pressure passage to the pressurizing chamber.

However, in the valve apparatus of JP2012-184745A (corresponding to US2012/0227711A1), the passages, which are not communicated with each other, are formed in the single valve seat portion, so that tilted holes and crossing holes are formed in the valve seat portion to make the complicated structure. Thereby, the number of process axes of the valve seat portion is increased, and the number of manufacturing steps is increased.

### SUMMARY

The present disclosure addresses the above disadvantages.

According to the present disclosure, there is provided a valve apparatus, which includes a valve housing, a first valve element, a first urging device, a second valve element, a second urging device, and a common seat portion. The first valve element is reciprocatably received in one end portion of the valve housing. The first urging device urges the first valve element toward another end portion of the valve housing, which is opposite from the one end portion of the valve housing. The second valve element is reciprocatably received in the another end portion of the valve housing. The second urging device urges the second valve element toward the one end portion of the valve housing. The common seat portion divides an inside of the valve housing into a first valve chamber, which receives the first valve element, and a second valve chamber, which receives the second valve element. The first valve element and the second valve element are seatable against and liftable away from the common seat portion. The common seat portion includes at least one first communication passage and at least one second communication passage. The at least one first communication passage communicates between the first valve chamber and the second valve chamber when the second valve element is lifted away from the common seat portion. The at least one second communication passage extends substantially parallel to the at least one first communication passage and communicates between the first valve chamber and the second valve chamber when the first valve element is lifted away from the common seat portion.

According to the present disclosure, there is also provided a high pressure pump, which includes a plunger, a main body portion, a fuel supply arrangement, and a fuel discharge arrangement. The main body portion is configured into a cup form and reciprocatably supports the plunger. The main body portion includes a pressurizing chamber, which has a variable volume that changes when the plunger is moved. The fuel supply arrangement supplies fuel to the pressurizing chamber. The fuel discharge arrangement includes the valve apparatus and discharges the fuel of the pressurizing chamber to an outside of the high pressure pump.

### BRIEF DESCRIPTION OF THE DRAWINGS

The drawings described herein are for illustration purposes only and are not intended to limit the scope of the present disclosure in any way.

FIG. 1 is a cross-sectional view of a high pressure pump taken along line I-I in FIG. 3 according to a first embodiment of the present disclosure;

FIG. 2 is a cross-sectional view taken along line II-II in FIG. 1;

FIG. 3 is a cross-sectional view taken along line III-III in FIG. 1;

FIG. 4A is a longitudinal cross-sectional view of a fuel discharge and relief arrangement shown at an area IVA in FIG. 1 according to the first embodiment;

FIG. 4B is a lateral cross-sectional view of the fuel discharge and relief arrangement taken along line IVB-IVB in FIG. 4A;

FIG. 5 is a longitudinal cross-sectional view of the fuel discharge and relief arrangement of the first embodiment, showing an operational state, in which a discharge valve member is lifted away from a common seat portion;

FIG. 6 is a longitudinal cross-sectional view of the fuel discharge and relief arrangement of the first embodiment, showing another operational state, in which a relief valve member is lifted away from the common seat portion;

FIG. 7 is a longitudinal cross-sectional view of a fuel discharge and relief arrangement according to a second embodiment of the present disclosure;

FIG. 8 is a longitudinal cross-sectional view of a fuel discharge and relief arrangement according to a third embodiment of the present disclosure;

FIG. 9 is a longitudinal cross-sectional view of a fuel discharge and relief arrangement according to a fourth embodiment of the present disclosure;

FIG. 10 is a longitudinal cross-sectional view of a fuel discharge and relief arrangement according to a fifth embodiment of the present disclosure;

FIG. 11A is a longitudinal cross-sectional view of a fuel discharge and relief arrangement taken along line XIA-XIA in FIG. 11B according to a sixth embodiment of the present disclosure;

FIG. 11B is a lateral cross-sectional view of the fuel discharge and relief arrangement taken along line XIB-XIB in FIG. 11A;

FIG. 12A is a longitudinal cross-sectional view of a fuel discharge and relief arrangement taken along line XIIA-XIIA in FIG. 12B according to a seventh embodiment of the present disclosure;

FIG. 12B is a lateral cross-sectional view of the fuel discharge and relief arrangement taken along line XIIB-XIIB in FIG. 12A; and

FIG. 13 is a longitudinal cross-sectional view of a fuel discharge and relief arrangement according to an eighth embodiment of the present disclosure.

### DETAILED DESCRIPTION

Various embodiments of the present disclosure will be described with reference to the accompanying drawings.

### First Embodiment

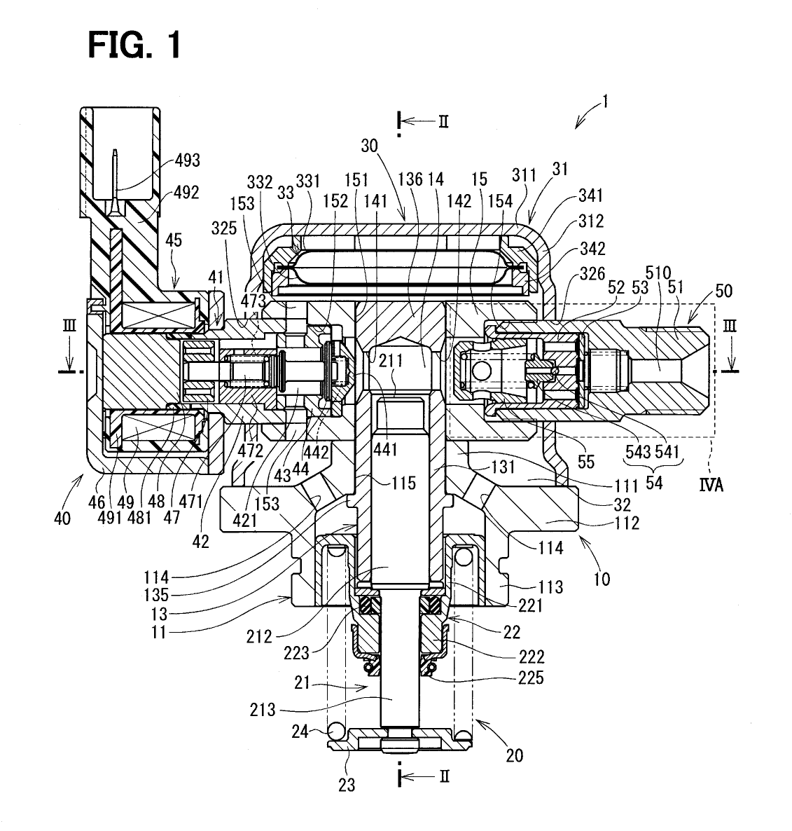

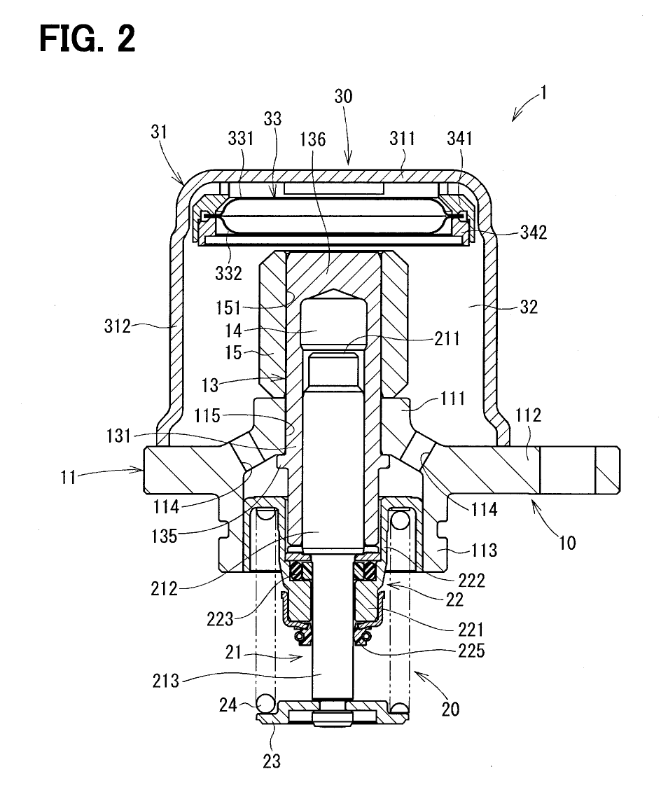

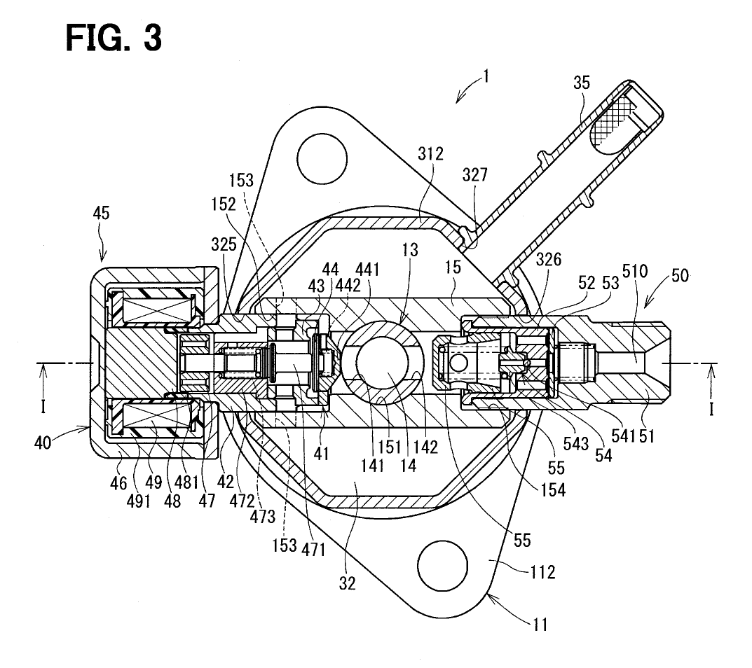

FIGS. 1 to 3 show a high pressure pump 1 according to a first embodiment of the present disclosure. The high pressure pump 1 pressurizes fuel supplied from a fuel tank (not shown) and discharges the pressurized fuel to a fuel rail connected to fuel injection valves. The high pressure pump 1 includes a main body 10, a fuel supply arrangement 30, a plunger arrangement 20, a fuel intake arrangement 40, and a fuel discharge and relief arrangement (also referred to as a fuel discharge arrangement) 50. The fuel discharge and relief arrangement 50 serves as a valve apparatus of the present disclosure. In the following description, an upper side of FIG. 1 will be described as an upper side, and a lower side of FIG. 1 will be described as a lower side.

The main body 10 includes a lower housing 11, a cylinder 13 and an upper housing 15.

The lower housing 11 includes a cylinder holding portion 111, a flange portion 112, and an engine fitting portion 113. The cylinder holding portion 111 is configured into a cylindrical tubular form. The flange portion 112 is configured into an annular form and projects radially outward from a lower part of the cylinder holding portion 111. The engine fitting portion 113 is configured into a cylindrical tubular form and projects downward from the flange portion 112. The cylinder holding portion 111 includes a cylinder press-fitting hole 115, through which the cylinder 13 is received. The cylinder holding portion 111 is configured to have an outer diameter that is smaller than an inner diameter of the engine fitting portion 113. The flange portion 112 includes a through-hole 114 between the cylinder holding portion 111 and the engine fitting portion 113.

The cylinder 13 includes a tubular portion 131, a bottom portion 136 and a projection 135. The tubular portion 131 slidably supports the plunger 21. The bottom portion 136 closes an upper end of the tubular portion 131. The projection 135 is configured into an annular form and radially outwardly projects at a location that is on a lower side of the cylinder holding portion 111. The cylinder 13, which serves as a main body portion, is secured to the cylinder press-fitting hole 115 of the cylinder holding portion 111 by press-fitting. The projection 135 limits upward movement of the cylinder 13.

The cylinder 13 includes a pressurizing chamber 14, which is defined by an inner wall of the tubular portion 131, an inner wall of the bottom portion 136 and an upper end surface 211 of the plunger 21. A volume of the pressurizing chamber 14 is changed through reciprocation of the plunger 21. In other words, the pressurizing chamber 14 has a variable volume that changes when the plunger 21 is moved. The tubular portion 131 includes an intake hole 141 and an discharge hole 142, which are communicated with the pressurizing chamber 14. The intake hole 141 and the discharge hole 142 are symmetrically arranged about a moving direction of the plunger 21. In other words, the intake hole 141 and the discharge hole 142 are symmetrically arranged about a central axis of the plunger 21.

The upper housing 15 is configured into an elongated parallelepiped form, which is elongated in a direction that connects between the intake hole 141 and the discharge hole 142. In other words, the upper housing 15 is elongated in a direction perpendicular to the central axis of the plunger 21. The upper housing 15 includes a cylinder press-fitting hole 151 at a longitudinal center of the upper housing 15. The cylinder 13 is fixed to the cylinder press-fitting hole 151 of the upper housing 15 by press-fitting.

The upper housing 15 includes an intake passage 152 and a plurality of through-holes 153. The intake passage 152 is communicated with the intake hole 141 of the cylinder 13. The through-holes 153 communicate between an inside and an outside of the upper housing 15. The intake passage 152 can conduct the fuel, which is drawn into the pressurizing chamber 14. The upper housing 15 further includes a discharge passage 154, which is communicated with the discharge hole 142 of the cylinder 13. The discharge passage 154 can conduct the fuel, which is discharged from the pressurizing chamber 14.

The fuel supply arrangement 30 includes a cover 31, a pulsation damper 33 and a fuel inlet 35.

The cover 31 is configured into a cup form and includes a cover bottom portion 311 and a cover tubular portion 312. The cover bottom portion 311 closes an upper end of the cover tubular portion 312. A lower end of the cover tubular portion 312 contacts an upper surface of the flange portion 112 of the lower housing 11. The cover 31 receives the upper housing 15 and an upper portion of the cylinder 13.

The cover tubular portion 312 includes a first fitting hole 325, a second fitting hole 326 and a third fitting hole 327, which are circumferentially spaced from each other. The first fitting hole 325 is formed at a location, which corresponds to the intake passage 152. A first intake valve body 42 is inserted into the first fitting hole 325 from the outside of the cover 31. The second fitting hole 326 is formed at a location, which corresponds to the discharge passage 154. A first discharge valve body 51 is inserted into the second fitting hole 326 from the outside of the cover 31. The fuel inlet 35 is inserted into the third fitting hole 327 from the outside of the cover 31.

The cover 31 is joined to the flange portion 112 by welding. The first intake valve body 42, the first discharge valve body 51, and the fuel inlet 35 are joined to the cover 31 by welding. A gap between the lower end of the cover 31 and the flange portion 112, a gap between the first fitting hole 325 and the first intake valve body 42, a gap between the second fitting hole 326 and the first discharge valve body 51, and a gap between the third fitting hole 327 and the fuel inlet 35 are fluid-tightly sealed through the above-described welding.

A fuel gallery 32, which is defined by the cover 31 and the flange portion 112, is formed in the cover 31. The fuel, which is supplied from the fuel inlet 35 to the fuel gallery 32, is supplied to the first intake valve body 42 through the through-hole 153.

The pulsation damper 33 is placed in the fuel gallery 32. The pulsation damper 33 includes two diaphragms 331, 332, each of which is configured into a circular dish form. The diaphragms 331, 332 are welded together along outer peripheral edges of the diaphragms 331, 332, and a gas of a predetermined pressure is sealed in an inside space, which is defined between the diaphragms 331, 332. The pulsation damper 33 is fixed to an inner wall of the cover 31 such that the outer peripheral edge of the pulsation damper 33 is clamped between an upper support body 341 and a lower support body 342. The pulsation damper 33 resiliently deforms in response to a pressure change of the fuel in the fuel gallery 32 to reduce a pressure pulsation of the fuel in the fuel gallery 32.

The plunger arrangement 20 includes the plunger 21, an oil seal holder 22, a spring seat 23 and a plunger spring 24. The plunger 21 is reciprocated by the plunger arrangement 20 in response to rotation of a camshaft to change a volume of the pressurizing chamber 14.

The plunger 21 includes a large diameter portion 212 and a small diameter portion 213. The large diameter portion 212 is supported by the cylinder 13 such that the large diameter portion 212 is slidable along the cylinder 13 in an axial direction of the cylinder 13. The small diameter portion 213 downwardly extends from the large diameter portion 212, and a lower end of the small diameter portion 213 contacts a tappet (not shown). The tappet contacts an outer peripheral surface of a cam, which is installed to the camshaft (not shown). When the camshaft is rotated, the tappet is axially reciprocated according to a cam profile of the cam.

The oil seal holder 22 includes a fixing portion 221 and a seal holding portion 222. The fixing portion 221 is fixed to the engine fitting portion 113 of the lower housing 11. The seal holding portion 222 is configured into a tubular form and is placed on a lower side of the cylinder 13. The seal holding portion 222 receives the small diameter portion 213 of the plunger 21. The seal holding portion 222 holds a seal 223. The seal 223 includes a Teflon (registered trademark) ring and an O-ring. The Teflon ring is placed on a radially inner side, and the O-ring is placed on a radially outer side. The seal 223 adjusts a thickness of a fuel oil film around the small diameter portion 213. Furthermore, an oil seal 225 is fixed to a lower end portion of the seal holding portion 222. The oil seal 225 adjusts an oil film thickness around the small diameter portion 213.

The spring seat 23 is fixed to a lower end portion of the plunger 21. One end of the plunger spring 24 is engaged with an upper surface of the spring seat 23, and the other end of the plunger spring 24 is engaged with the fixing portion 221 of the oil seal holder 22. The plunger spring 24 functions as a return spring of the plunger 21 and urges the plunger 21 against the tappet.

The fuel intake arrangement 40 includes an intake valve device 41 and a solenoid drive device 45.

The intake valve device 41 includes an intake valve body 42, a seat body 43, an intake valve member 44, a first spring holder 441 and a first spring 442.

The intake valve body 42 is, for instance, press-fitted to the intake hole 141, and thereby the intake valve body 42 is connected to the upper housing 15. The intake valve body 42 has an intake chamber 421 in an inside of the intake valve body 42. The intake chamber 421 is communicated with the fuel gallery 32 through the through-hole 153. The seat body 43, which is configured into a generally cylindrical tubular form, is received in the intake chamber 421. A valve seat is formed in the seat body 43 on a pressurizing chamber 14 side and is engageable with the intake valve member 44.

The intake valve member 44 is placed on a pressurizing chamber 14 side of the seat body 43. The intake valve member 44 reciprocates in the intake chamber 421. The intake valve member 44 communicates between the intake chamber 421 and the pressurizing chamber 14 when the intake valve member 44 is lifted away from the valve seat of the seat body 43. The intake valve member 44 interrupts the communication between the intake chamber 421 and the pressurizing chamber 14 when the intake valve member 44 is seated against the valve seat.

The first spring holder 441 is fixed to the fuel intake arrangement 40 on the pressurizing chamber 14 side. The first spring holder 441 limits movement of the intake valve member 44 toward the pressurizing chamber 14.

The first spring 442 is placed between the first spring holder 441 and the intake valve member 44. The first spring 442 urges the intake valve member 44 in a seating direction (a valve closing direction) of the intake valve member 44 against the valve seat of the seat body 43. In other words, the first spring 442 urges the intake valve member 44 against the valve seat of the seat body 43.

The solenoid drive device 45 includes a case 46, a movable core 47, a stationary core 48, and a coil 49.

The case 46 is configured into a cup form and is placed on an opposite side of the intake valve body 42, which is opposite from a side where the intake valve body 42 is connected to the upper housing 15. The movable core 47, the stationary core 48 and the coil 49 are received in the case 46.

The movable core 47 is reciprocatable in the axial direction of the intake valve body 42. A needle 471 is connected to the movable core 47. The needle 471 is reciprocatably supported by a second spring holder 472, which is fixed to an inner wall of the intake valve body 42. One end portion of the needle 471 is fixed to the movable core 47, and the other end portion of the needle 471 is contactable with the intake valve member 44. One end of a second spring 473 contacts the second spring holder 472. The second spring 473 urges the needle 471 toward the pressurizing chamber 14 by an urging force, which is larger than an urging force of the first spring 442, which urges the intake valve member 44 in the valve-closing direction of the intake valve member 44.

The stationary core 48 is placed on an opposite side of the movable core 47, which is opposite from the intake valve member 44. A tubular member 481, which is made of a non-magnetic material, is placed between the stationary core 48 and the intake valve body 42. The tubular member 481 limits short circuit of a magnetic flux between the stationary core 48 and the intake valve body 42 and increases the amount of the magnetic flux, which flows through a magnetic gap between the movable core 47 and the stationary core 48.

The coil 49 is wound around the bobbin 491, which is made of a resin material and is placed on a radially outer side of the stationary core 48. The coil 49 is connected to an electric power source (an electric power supplying means) through terminals 493 of a connector 492 that radially outwardly extends from the case 46.

When the coil 49 is not energized, the movable core 47 and the stationary core 48 are spaced from each other by a resilient force of the second spring 473. Thereby, the needle 471, which is integrated with the movable core 47, is moved toward the pressurizing chamber 14, so that an end surface of the needle 471 urges the intake valve member 44 to open the intake valve device 41.

When the coil 49 is energized, a magnetic attractive force is generated by a magnetic circuit made of the stationary core 48, the movable core 47 and the case 46 to magnetically attract between the movable core 47 and the stationary core 48. Thereby, the movable core 47 is moved toward the stationary core 48 against the resilient force of the second spring 473. In this way, the urging force, which is applied to the needle 471 against the intake valve member 44, is released. Thus, the intake valve device 41 is closed.

The fuel discharge and relief arrangement 50 includes the first discharge valve body (serving as a valve housing) 51, a common seat portion 52, a discharge valve member (serving as a second valve element) 53, a relief valve member (serving as a first valve element) 54, and a second discharge valve body 55.

The first discharge valve body 51 is configured into a cylindrical tubular form and is fixed to the upper housing 15 such that the first discharge valve body 51 is communicated with the discharge passage 154. The first discharge valve body 51 receives the common seat portion 52, the discharge valve member 53, the relief valve member 54, and a portion of the second discharge valve body 55. An inside of the first discharge valve body 51 is divided into a first valve chamber 511 and a second valve chamber 512 by the common seat portion 52.

The first valve chamber 511 is formed in an end portion 515 of the first discharge valve body 51, which is fixed to the upper housing 15. The first valve chamber 511 receives the relief valve member 54 and a portion of the second discharge valve body 55. The first valve chamber 511 is communicated with the pressurizing chamber 14 through the discharge passage 154 and the discharge hole 142.

The second valve chamber 512 is formed in an end portion 516 of the first discharge valve body 51, which is opposite from the end portion 515 fixed to the upper housing 15 of the first discharge valve body 51. The second valve chamber 512 receives the discharge valve member 53. The second valve chamber 512 is communicated with an outside of the high pressure pump 1 through a fuel discharge outlet 510, which is formed in the end portion 516 of the first discharge valve body 51. The end portion 515 corresponds to one end portion of the valve housing of the present disclosure. The end portion 516 corresponds to another end portion of the valve housing of the present disclosure.

The common seat portion 52 is configured into a cup form and has an opening on the discharge passage 154 side. A bottom part 520 of the common seat portion 52 includes a plurality of discharge passages 521 and a relief passage 522. Communication between the first valve chamber 511 and the second valve chamber 512 through the discharge passages 521 and the communication between the first valve chamber 511 and the second valve chamber 512 through the relief passage 522 can be executed independently from each other.

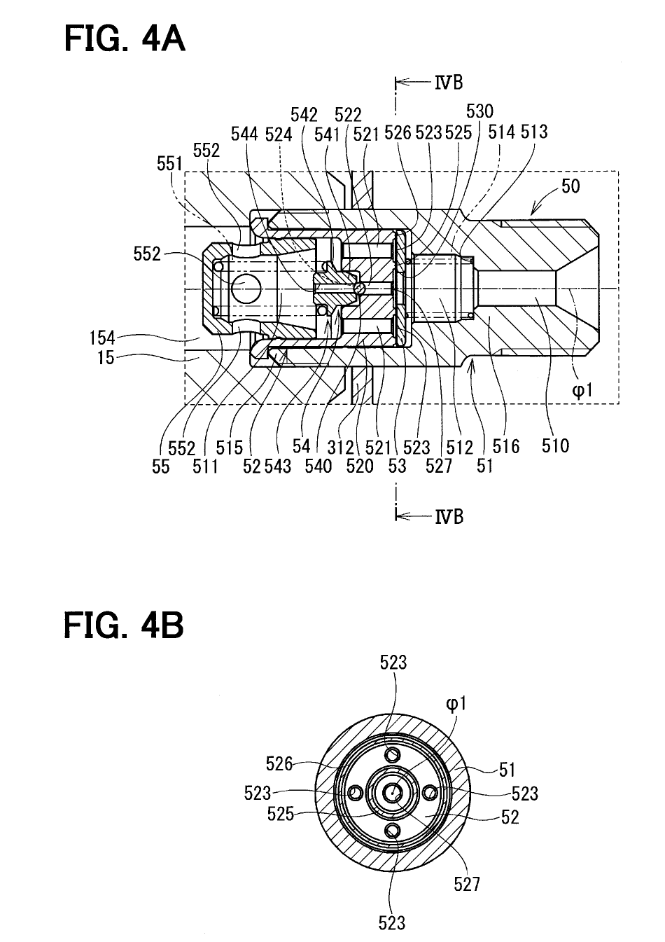

In the high pressure pump 1 of the first embodiment, the number of the discharge passages (serving as first passages) 521 is four. The discharge passages 521 extend substantially parallel to the central axis φ1 of the common seat portion 52. As shown in FIG. 4B, openings 523 of the discharge passages 521, which are located on the second valve chamber 512 side, are arranged one after another at generally equal intervals along a circle, which is coaxial with the central axis φ1 of the common seat portion.

The relief passage 522 is substantially parallel to the central axis φ1 of the common seat portion 52. In the high pressure pump 1 of the first embodiment, the relief passage 522, which serves as a second communication passage, extends along the central axis φ1. Specifically, the discharge passages 521 are placed on a radially outer side of the relief passage 522. A cross-sectional area (also referred to as a total cross-sectional area) of the relief passage 522 is smaller than a sum of cross-sectional areas of the discharge passages 521 (i.e., a total cross-sectional area of the discharge passages 521).

The relief passage 522 has an opening 524 on the first valve chamber 511 side such that the opening 524 is formed in a recess of the bottom part 520 of the common seat portion 52. A projection 541 of the relief valve member 54 can be inserted into the recess of the bottom part 520.

The common seat portion 52 includes annular projections (ring projections) 525, 526, which are annular and are formed in an end surface of the bottom part 520 located on the second valve chamber 512 side and project toward the second valve chamber 512 side. The projections 525, 526 are contactable with the discharge valve member 53. The projection 525 serves as a first projection and is formed in a peripheral edge part, which surrounds and forms the opening 527 of the relief passage 522 located on the second valve chamber 512 side. The projection 526 is placed on a radially outer side of the openings 523 of the discharge passage 521.

The discharge valve member 53 is an annular metal member (a metal ring), which is placed on an opposite side of the bottom part 520 of the common seat portion 52, which is opposite from the pressurizing chamber 14. A discharge valve spring (serving as a second urging device or a second urging means) 514 urges the discharge valve member 53 against the projections 525, 526. One end of the discharge valve spring 514 is supported by a stepped surface 513 formed in an inner wall of the first discharge valve body 51. The discharge valve member 53 is liftable away from and seatable against the projections 525, 526 to enable and disable communication between the discharge passage 521 and the second valve chamber 512.

A through-hole 530 extends though the discharge valve member 53 at a location, which corresponds to the opening 527 of the relief passage 522. The through-hole 530 communicates between the second valve chamber 512 and the relief passage 522 when the discharge valve member 53 closes the discharge passage 521. Specifically, the second valve chamber 512 and the relief passage 522 are always communicated with each other regardless of whether the discharge valve member 53 contacts the projections 525, 526.

The relief valve member 54 is placed on the discharge passage 154 side of the bottom part 520 of the common seat portion 52. The relief valve member 54 includes a seal member 540, and a main body 543. The seal member 540 is configured into a spherical form. The main body 543 includes a projection 541 and a stopper portion 542, which are formed integrally and seamlessly. The stopper portion 542 has an outer diameter, which is larger than an outer diameter of the projection 541.

The seal member 540 contacts a peripheral edge part that surrounds and forms a second valve chamber 512 side opening of the through-hole 544, which is formed generally at the center of the main body 543. Furthermore, the seal member 540 is contactable with the peripheral edge part, which surrounds and forms the opening 524 of the relief passage 522.

The main body 543 is urged by a relief valve spring (serving as a first urging device or a first urging means) 551, which is supported by the inner wall of the second discharge valve body 55, so that the seal member 540 is urged to contact the peripheral edge part, which surrounds and forms the opening 527. The relief valve member 54 enables and disables communication between the relief passage 522 and the first valve chamber 511.

The second discharge valve body 55 is configured into a cup form. A plurality of through-holes 552 is formed through a peripheral wall (side wall) of the second discharge valve body 55. In the high pressure pump 1 of the first embodiment, the number of the through-holes 552 is four, and these through-holes 552 are arranged one after another in a circumferential direction. The through-holes 552 communicate between the discharge passage 154 and the second valve chamber 512.

Next, the operating the high pressure pump 1 will be described.

When the plunger 21 is moved downward from the top dead center to the bottom dead center through rotation of the camshaft, the volume of the pressurizing chamber 14 is increased to result in a decrease in the pressure in the pressurizing chamber 14. At this time, the communication between the discharge passage 154 and the fuel discharge outlet 510 is interrupted by the discharge valve member 53. Furthermore, when the energization of the coil 49 is stopped, the needle 471 is moved toward the intake valve device 41 by the urging force of the second spring 473. In this way, the needle 471 urges the intake valve member 44, and thereby the intake valve member 44 is lifted away from the seat body 43. Thus, the intake chamber 421 and the pressurizing chamber 14 are communicated with each other, and the fuel from the intake chamber 421 and the fuel gallery 32 is drawn into the pressurizing chamber 14.

When the plunger 21 is moved upward from the bottom dead center toward the top dead center through the rotation of the camshaft, the volume of the pressurizing chamber 14 is decreased. At this time, the energization of the coil 49 is stopped until predetermined timing (predetermined time point), so that the intake chamber 421 and the pressurizing chamber 14 are communicated with each other, and a portion of the low pressure fuel, which is drawn into the pressurizing chamber 14, is returned to the intake chamber 421.

When the energization of the coil 49 is started at the predetermined timing (predetermined time point) during the upward movement of the plunger 21, the magnetic attractive force is generated between the stationary core 48 and the movable core 47. When this magnetic attractive force becomes larger than a resultant force, which is obtained by subtracting the urging force of the first spring 442 from the urging force of the second spring 473, the movable core 47 and the needle 471 are moved toward the stationary core 48. In this way, the urging force of the needle 471 against the intake valve member 44 is released. The intake valve member 44 is seated against the valve seat of the first spring holder 441 by the urging force of the first spring 442 and a dynamic pressure generated by the flow of the fuel. Thereby, the communication between the intake chamber 421 and the pressurizing chamber 14 is interrupted.

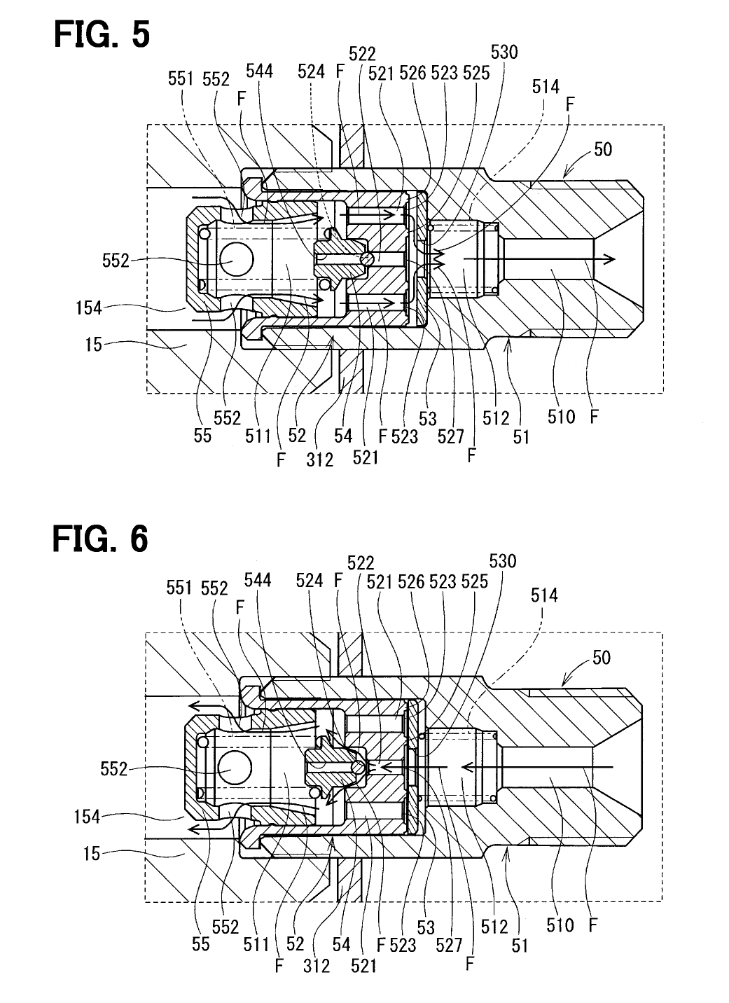

Once the communication between the intake chamber 421 and the pressurizing chamber 14 is interrupted, the volume of the pressurizing chamber 14 is reduced due to the upward movement of the plunger 21, and the pressure of the fuel in the pressurizing chamber 14 is increased. The pressure of the fuel in the pressurizing chamber 14 is exerted against the discharge valve member 53 through the discharge hole 142, the discharge passage 154, the first valve chamber 511 and the discharge passages 521. As shown in FIG. 5, the discharge valve member 53 is moved toward the fuel discharge outlet 510 and is thereby lifted away from the common seat portion 52 when a product of a cross-sectional area (a total cross-sectional area) of the discharge passages 521 and the pressure of the fuel of the pressurizing chamber 14 (the pressure of the first valve chamber 511) exerted against the discharge valve member 53 is larger than a sum of the urging force of the discharge valve spring 514 and a product of the pressure of the fuel of the second valve chamber 512 and a pressure receiving surface area S1 of the discharge valve member 53 at the fuel discharge outlet 510 side. In this way, the fuel of the pressurizing chamber 14 flows to the fuel discharge outlet 510 through the second valve chamber 512. Arrows F shown in FIG. 5 indicate a corresponding flow of the fuel. Furthermore, the pressure receiving surface area S1 is a surface area, which is obtained by subtracting a cross-sectional area of the through-hole 530 from a cross-sectional area of the discharge valve member 53. The pressure receiving surface area S1 corresponds to a pressure receiving surface area of the second valve element, which receives the pressure of the second valve chamber, according to the present disclosure.

Furthermore, for instance, in a case where the pressure of the fuel of the fuel discharge outlet 510 becomes equal to or larger than a predetermined value due to a trouble on the downstream side of the high pressure pump 1, the pressure of the fuel of the fuel discharge outlet 510 is exerted against the relief valve member 54 through the second valve chamber 512 and the relief passage 522. As shown in FIG. 6, the relief valve member 54 is moved toward the discharge passage 154 and is thereby lifted away from the common seat portion 52 when a product of the pressure of the fuel discharge outlet 510 (the pressure of the second valve chamber 512) exerted against the relief valve member 54 and a cross-sectional area (a total cross-sectional area) of the relief passage 522 is larger than a sum of an urging force of the relief valve spring 551 and a product of the pressure of the fuel of the first valve chamber 511 and a pressure receiving surface area S2 of the relief valve member 54 at the discharge passage 154 side. In this way, the fuel of the fuel discharge outlet 510 flows to the discharge passage 154 through the first valve chamber 511. Arrows F shown in FIG. 6 indicate a corresponding flow of the fuel. Furthermore, the pressure receiving surface area S2 is a cross-sectional area of the main body 543 of the relief valve member 54. The pressure receiving surface area S2 corresponds to a pressure receiving surface area of the first valve element, which receives the pressure of the first valve chamber, according to the present disclosure.

The high pressure pump 1 repeats an intake stroke of drawing the fuel into the pressurizing chamber 14, a return stroke of returning a portion of the fuel of the pressurizing chamber 14 to the fuel intake arrangement 40, a pressurizing stroke of pressurizing the fuel, and a discharge stroke of discharging the fuel to the outside. At this time, the fuel discharge and relief arrangement 50 discharges the pressurized fuel from the fuel discharge outlet 510. Furthermore, when the pressure of the fuel of the fuel discharge outlet 510 becomes equal to or higher than a predetermined value, the relief valve member 54 is lifted away from the common seat portion 52 to communicate between the first valve chamber 511 and the second valve chamber 512. Thereby, the fuel of the fuel discharge outlet 510 is returned to the pressurizing chamber 14.

(a) In the high pressure pump 1 of the first embodiment, the communication between the first valve chamber 511 and the second valve chamber 512 through the discharge passages 521 of the common seat portion 52 and the communication between the first valve chamber 511 and the second valve chamber 512 through the relief passage 522 are executed independently from each other. The discharge valve member 53 is contactable with a peripheral edge part, which surrounds the openings 523 of the discharge passages 521 located on the second valve chamber 512 side. Furthermore, the relief valve member 54 is contactable with the peripheral edge part, which surrounds and forms the opening 524 of the relief passage 522 located on the first valve chamber 511 side. In this way, the flow of the fuel from the first valve chamber 511 to the second valve chamber 512 and the flow of the fuel from the second valve chamber 512 to the first valve chamber 511 are controlled because of the balance among the pressure of the fuel of the first valve chamber 511, the pressure of the fuel of the second valve chamber 512, the urging force of the discharge valve spring 514, and the urging force of the relief valve spring 551. The discharge passages 521 and the relief passage 522 are substantially parallel to the central axis φ1 of the common seat portion 52. At the time of manufacturing the high pressure pump 1 according to the first embodiment, the number of process axes relative to the common seat portion 52 is reduced in comparison to the case where the communication passage for discharging the fuel and the communication passage for relieving the pressure of the fuel are formed through connection of the multiple passages. In this way, the structure of the fuel discharge and relief arrangement 50 can be simplified, and the number of the manufacturing steps of the high pressure pump 1 can be reduced.

(b) Each of the discharge passages 521 and the relief passage 522 is formed by the corresponding linear flow passage. Therefore, the amount of burrs generated during the processing time can be reduced in comparison to the case where the communication passage is formed through the connection of the multiple flow passages. Thereby, the burrs can be easily removed. Therefore, the manufacturing costs of the high pressure pump 1 can be reduced or minimized.

(c) In the high pressure pump 1 of the first embodiment, the annular projections 525, 526 are formed in the end surface of the common seat portion 52 located on the second valve chamber 512 side. In this way, at the time of contacting the discharge valve member 53 against the projections 525, 526, the airtightness between the discharge passage 521 and the second valve chamber 512 can be maintained.

### Second Embodiment

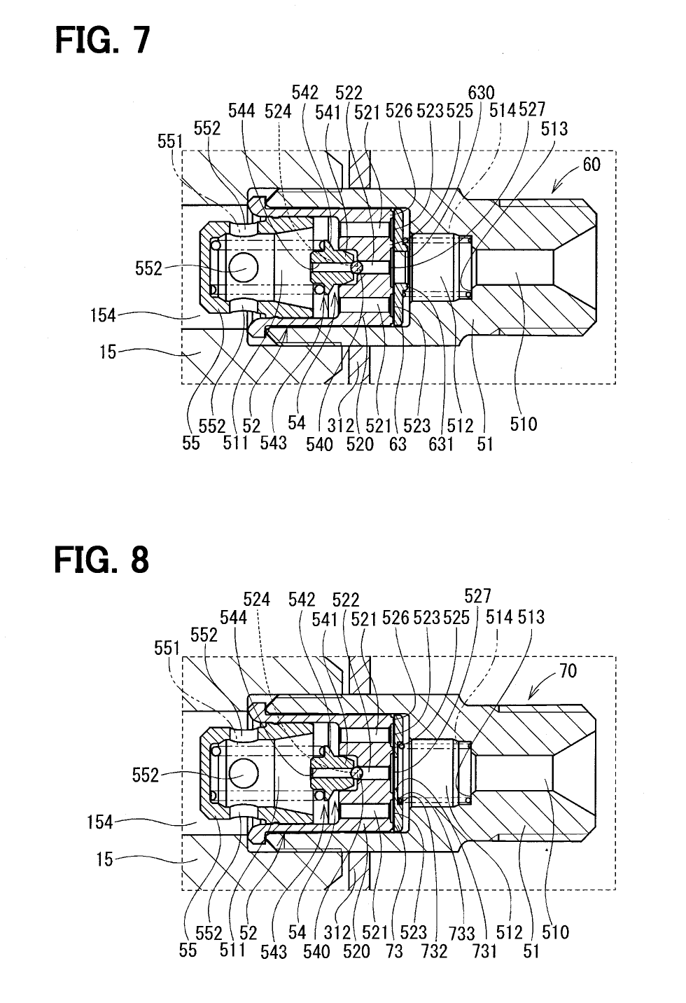

Next, a fuel discharge and relief arrangement of a second embodiment of the present disclosure will be described with reference to FIG. 7. The second embodiment is substantially the same as that of the first embodiment except the configuration of the discharge valve member. In the following description, components, which are similar to those of the first embodiment, will be indicated by the same reference numerals and will not be described further.

The fuel discharge and relief arrangement 60, which is installed in the high pressure pump according to the second embodiment, has an annular projection 631 at the fuel discharge outlet 510 of the discharge valve member (serving as the second valve element) 63. Specifically, as shown in FIG. 7, the projection 631 is formed in a peripheral edge part, which surrounds and forms the through-hole 630. A stepped surface is formed between the projection 631 and an end surface of the discharge valve member 63 located on the fuel discharge outlet 510 side. The projection 631 corresponds to a guide portion of the present disclosure.

In the high pressure pump according to the second embodiment, the other end of the discharge valve spring 514 is engaged with the stepped surface, which is formed between the projection 631 and the end surface of the discharge valve member 63 located on the fuel discharge outlet 510 side. In this way, the urging force of the discharge valve spring 514, which is exerted against the discharge valve member 63, is stabilized. Therefore, the high pressure pump of the second embodiment can achieve the advantages, which are similar to those of the first embodiment. Also, the high pressure pump of the second embodiment can stabilize the threshold value of the pressure of the first valve chamber 511 at the time of communicating between the first valve chamber 511 and the second valve chamber 512.

### Third Embodiment

Next, a fuel discharge and relief arrangement of a third embodiment of the present disclosure will be described with reference to FIG. 8. The third embodiment is substantially the same as that of the first embodiment except the configuration of the discharge valve member. In the following description, components, which are similar to those of the first embodiment, will be indicated by the same reference numerals and will not be described further.

The fuel discharge and relief arrangement 70, which is installed in the high pressure pump according to the third embodiment, includes a through-hole 731 and a through-hole 732, which are formed in the discharge valve member 73 and have different inner diameters, respectively. The through-hole 731 is formed in the discharge valve member 73 on the common seat portion 52 side. The through-hole 732 is formed in the discharge valve member 73 on the fuel discharge outlet 510 side and has the inner diameter, which is larger than the inner diameter of the through-hole 731. The through-hole 731 and the through-hole 732 are communicated with each other to communicate between the common seat portion 52 side of the discharge valve member 73 and the fuel discharge outlet 510 side of the discharge valve member 73. A stepped surface (serving as a guide portion) 733 is formed between the through-hole 731 and the through-hole 732.

In the high pressure pump according to the third embodiment, the other end of the discharge valve spring 514 is engaged with the stepped surface 733. In this way, the urging force of the discharge valve spring 514, which is exerted against the discharge valve member 73, is stabilized. Therefore, the high pressure pump of the third embodiment can achieve the advantages, which are similar to those of the first embodiment. Also, the high pressure pump of the third embodiment can stabilize the threshold value of the pressure of the first valve chamber 511 at the time of communicating between the first valve chamber 511 and the second valve chamber 512.

### Fourth Embodiment

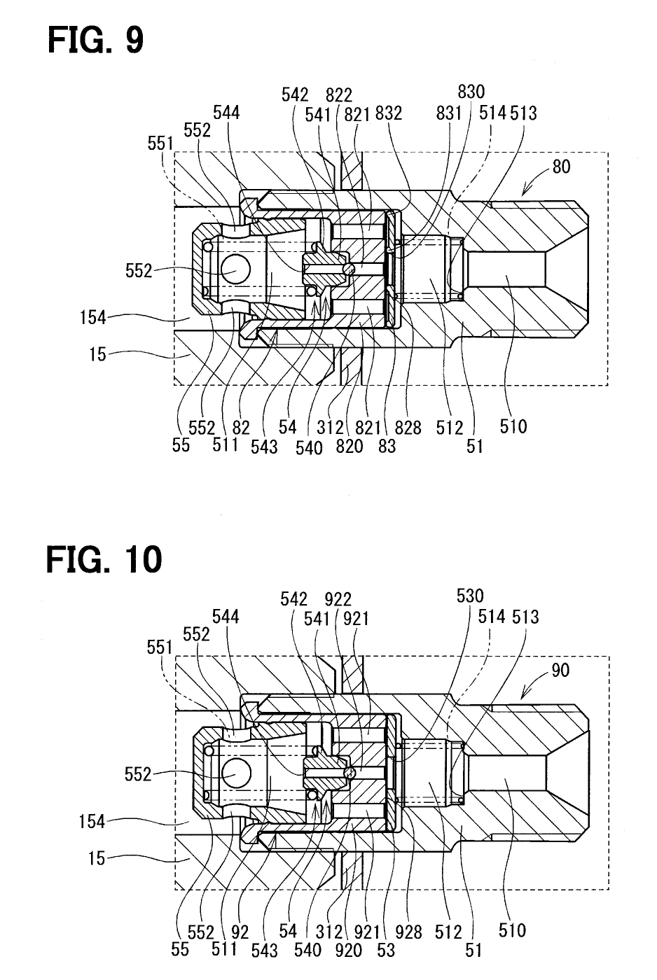

Next, a fuel discharge and relief arrangement of a fourth embodiment of the present disclosure will be described with reference to FIG. 9. The fourth embodiment is substantially the same as that of the first embodiment except the configuration of the discharge valve member and the configuration of the common seat portion. In the following description, components, which are similar to those of the first embodiment, will be indicated by the same reference numerals and will not be described further.

The fuel discharge and relief arrangement 80, which is installed in the high pressure pump according to the fourth embodiment, includes an annular projection 831 and an annular projection 832, which are formed in the discharge valve member (serving as the second valve element) 83 on the common seat portion 82 side. The projections (serving as second projections) 831, 832 can contact the common seat portion 82. The projection 831 is formed in a peripheral edge part, which surrounds and forms the opening of the through-hole 830 located on the common seat portion 82 side. The through-hole 830 is placed at a location, which corresponds to the relief passage (serving as the second communication passage) 822 of the common seat portion 82. The projection 832 is located on the radially outer side of the openings of the discharge passages (serving as the first communication passages) 821 located on the second valve chamber 512 side. An end surface 828 of the bottom part 820 of the common seat portion 82 located on the second valve chamber 512 side is formed as a planar surface.

When the common seat portion 82 contacts the discharge valve member 83, the end surface 828 of the common seat portion 82 contacts the projections 831, 832 to maintain the airtightness between the discharge passage 521 and the second valve chamber 512.

In the high pressure pump of the fourth embodiment, the end surface 828 of the bottom part 820 of the common seat portion 82 located on the second valve chamber 512 side is formed as the planar surface, and the projections 831, 832, which can contact the common seat portion 82, are formed in the discharge valve member 83. When the high pressure pump of the fourth embodiment is compared with the high pressure pump of the first embodiment, the processing costs may possibly be reduced by forming the projections 831, 832 in the discharge valve member 83 in comparison to the case where the projections are formed in the bottom part 520 of the common seat portion 52. In this way, the high pressure pump of the fourth embodiment can achieve the advantages, which are similar to the advantages of the first embodiment, and can further reduce the processing costs.

### Fifth Embodiment

Next, a fuel discharge and relief arrangement of a fifth embodiment of the present disclosure will be described with reference to FIG. 10. The fifth embodiment is substantially the same as that of the first embodiment except the configuration of the common seat portion. In the following description, components, which are similar to those of the first embodiment, will be indicated by the same reference numerals and will not be described further.

In the high pressure pump of the fifth embodiment, the end surface 928 of the bottom part 920 of the common seat portion 92 of the fuel discharge and relief arrangement 90 is formed as a planar surface. When the common seat portion 92 contacts the discharge valve member 53, the end surface 928 of the common seat portion 92 contacts the end surface of the discharge valve member 53 located on the common seat portion 92 side.

In the high pressure pump of the fifth embodiment, when the common seat portion 92 contacts the discharge valve member 53, the first valve chamber 511 and the second valve chamber 512 are communicated with each other through the relief passage (serving as the second communication passage) 922 and the through-hole 530 of the discharge valve member 53, and the airtightness of a certain degree can be achieved between the discharge passages (serving as the first communication passages) 921 of the common seat portion 92 and the second valve chamber 512. In this way, the high pressure pump of the fifth embodiment can reduce the processing costs of the common seat portion 92 in comparison to the case where the projections are formed in the common seat portion or the discharge valve member. Therefore, the high pressure pump of the fifth embodiment can achieve the advantages discussed in the sections (a) and (b) of the first embodiment and can further reduce the processing costs.

### Sixth Embodiment

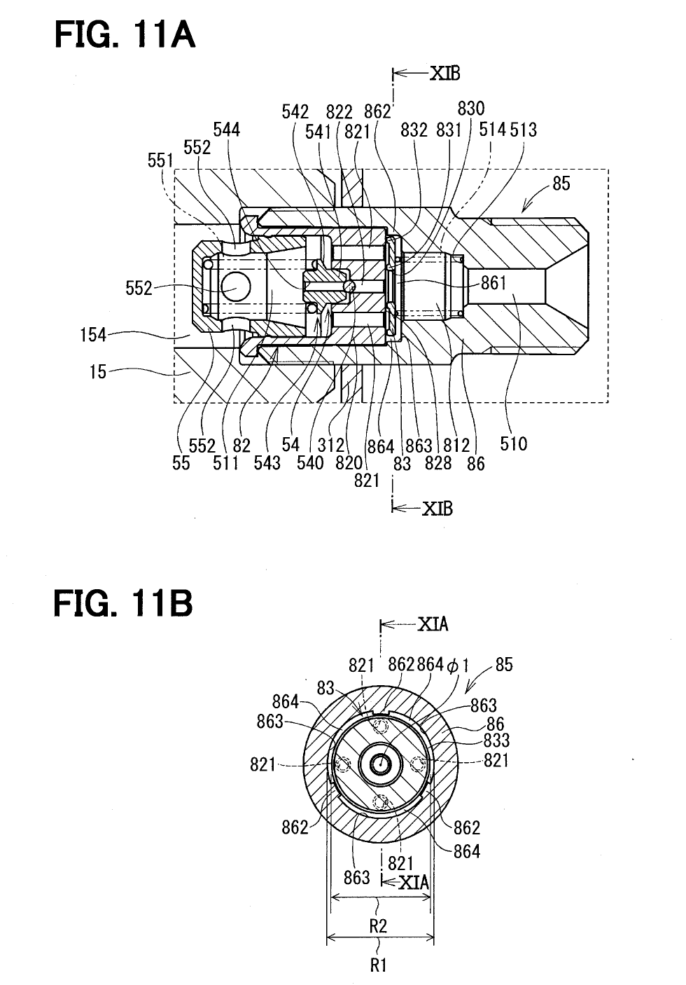

Next, a fuel discharge and relief arrangement of a sixth embodiment of the present disclosure will be described with reference to FIGS. 11A and 11B. The sixth embodiment is substantially the same as that of the fourth embodiment except the configuration of the second valve chamber, which reciprocatably receives the discharge valve member. In the following description, components, which are similar to those of the fourth embodiment, will be indicated by the same reference numerals and will not be described further.

In the high pressure pump of the sixth embodiment, the first discharge valve body (serving as the valve housing) 86 of the fuel discharge and relief arrangement 85 includes the second valve chamber 812. The discharge valve chamber 861, which is located on the common seat portion 82 side of the second valve chamber 812, reciprocatably receives the discharge valve member 83. As shown in FIG. 11B, a plurality of projections 862 is formed in an inner wall of the discharge valve chamber 861 and contacts a radially outer wall (outer peripheral wall) 833 of the discharge valve member 83 located on the radially outer side. In the sixth embodiment, the number of the projections 862 is three. The discharge valve member 83 reciprocates in the discharge valve chamber 861 while the discharge valve member 83 slides along the projections 862. That is, the projections 862 serve as guides, which guide the discharge valve member 83.

An inner diameter R1 of the inner wall 863 of the discharge valve chamber 861, which does not have the projections 862, is larger than an outer diameter R2 of the discharge valve member 83. Thereby, a gap 864 is formed between the inner wall 863 of the discharge valve chamber 861 and the radially outer wall 833 of the discharge valve member 83.

In the high pressure pump of the sixth embodiment, when the discharge valve member 83 is lifted away from the common seat portion 82 to communicate between the discharge passage 821 and the second valve chamber 812, the fuel flows from the discharge passage 821 to the fuel discharge outlet 510 through the discharge valve chamber 861. At this time, the fuel passes through the gap 864. Therefore, in the sixth embodiment, the larger amount of fuel can flow to the discharge outlet 610 in comparison to the fourth embodiment. Thereby, the high pressure pump of the sixth embodiment can achieve the same advantages as those of the first embodiment and can discharge the larger amount of fuel to the fuel rail.

### Seventh Embodiment

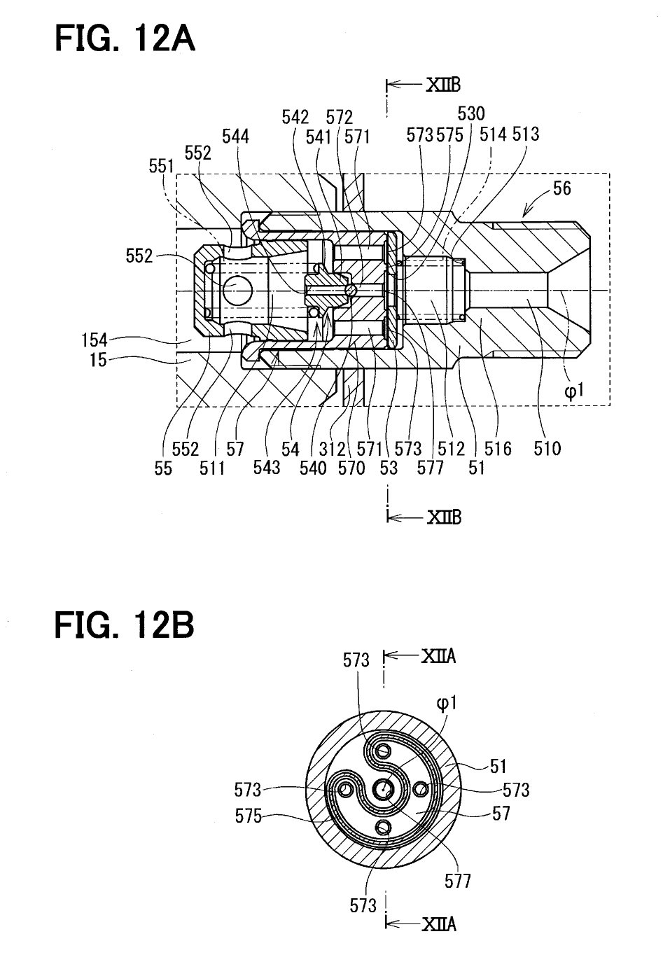

Next, a fuel discharge and relief arrangement of a seventh embodiment of the present disclosure will be described with reference to FIGS. 12A and 12B. In the seventh embodiment, the projections, which are formed in the side of the common seat portion located on the discharge valve member side, differ from those of the first embodiment. In the following description, components, which are similar to those of the first embodiment, will be indicated by the same reference numerals and will not be described further.

The common seat portion 57 of the fuel discharge and relief arrangement 56, which is formed in the high pressure pump of the seventh embodiment, includes a projection (serving as the first projection of the present disclosure) 575. The projection 575 is formed in and projects from the end surface of the bottom part 570 (a peripheral edge part of the bottom part 570, which forms openings 573 of the discharge passages 571) located on the second valve chamber 512 side. As shown in FIG. 12B, the projection 575 is formed continuously to surround the four openings 573 of the discharge passages 571 located on the second valve chamber 512 side. Furthermore, the projection 575 does not surround the opening 577 of the relief passage 572 located on the second valve chamber 512 side. Therefore, the projection 575 has a cross section, which is configured into a horseshoe shape, as shown in FIG. 12B.

In the high pressure pump of the seventh embodiment, when the discharge valve member 53 contacts the projection 575, the communication between the discharge passages 571 and the second valve chamber 512 is interrupted. When the pressure of the fuel in the discharge passages 571 is increased, the discharge valve member 53 is lifted away from the projection 575. Thereby, the fuel flows from the discharge passages 571 to the second valve chamber 512.

A height (projecting height) of the projection 575, which is formed continuously, can be easily uniformly formed in the manufacturing process. Thereby, when the discharge valve member 53 contacts the projection 575, the fluid-tightness between the discharge passages 571 and the second valve chamber 512 can be reliably maintained. Thus, the high pressure pump of the seventh embodiment can achieve the advantages, which are similar to those of the first embodiment, and can improve the sealing of the fuel discharge and relief arrangement 56.

### Eighth Embodiment

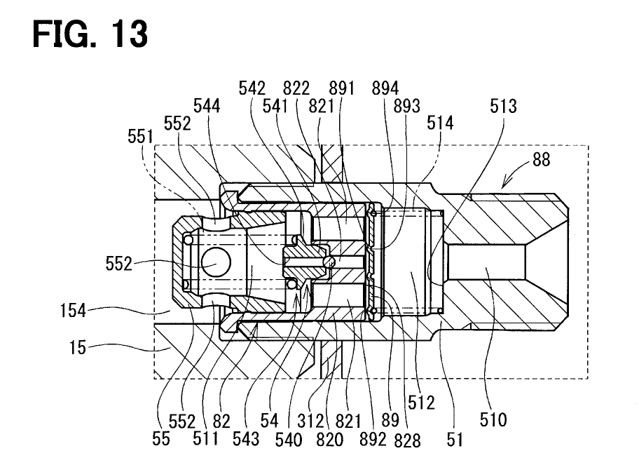

Next, a fuel discharge and relief arrangement of an eighth embodiment of the present disclosure will be described with reference to FIG. 13. The eighth embodiment is substantially the same as that of the fourth embodiment except the configuration of the discharge valve member. In the following description, components, which are similar to those of the fourth embodiment, will be indicated by the same reference numerals and will not be described further.

In the high pressure pump of the seventh embodiment, the fuel discharge valve member (serving as the second valve element) 89 of the fuel discharge and relief arrangement 88 is formed through press forming of a single planar plate member. In other words, the fuel discharge valve member 89 is integrally and seamlessly formed as a plate valve member through the press forming. Projections (serving as second projections) 891, 892 are formed in the side of the discharge valve member 89 located on the common seat portion 82 side to project toward the common seat portion 82. The projection 891 and the projection 892 are generally concentrically arranged about the center of the discharge valve member 89. Furthermore, a recess 893 and a recess 894, which correspond to the projection 891 and the projection 892, respectively, are formed in the opposite side of the discharge valve member 89, which is opposite from the common seat portion 82. The recesses 893, 894 are formed simultaneously with the projections 891, 892 at the time of forming the projections 891, 892 through the press forming. The recess 894 supports one end of the discharge valve spring 514. The recess 894 corresponds to the guide portion of the present disclosure.

In the high pressure pump of the eighth embodiment, the discharge valve member 89 is formed from the single planar plate member. Thereby, the high pressure pump of the eighth embodiment can achieve the advantages, which are similar to those of the first embodiment. Furthermore, the high pressure pump of the eighth embodiment can ease the manufacturing of the discharge valve member 89 and can improve the dimensional accuracy of the discharge valve member 89.

Furthermore, the one end of the discharge valve spring 514 is supported by the recess 894, which is formed simultaneously with the projection 892. Therefore, the extending direction of the discharge valve spring 514 and the projecting direction of the projections 891, 892 are located along a common axis, i.e., coincide with each other. Thus, the urging force of the discharge valve spring 514 is stabilized. As a result, the high pressure pump of the eighth embodiment can stabilize a threshold value of the pressure of the first valve chamber 511 at the time of communicating between the first valve chamber 511 and the second valve chamber 512.

Now, modifications of the above embodiments will be described.

(A) In the above embodiments, the valve apparatus of the present disclosure is used in the fuel discharge and relief arrangement of the high pressure pump. However, the application of the valve apparatus of the present disclosure is not limited to this, and the valve apparatus of the present disclosure may be applied to any other suitable arrangement or apparatus. That is, the valve apparatus may be in another arrangement or apparatus, in which because of the balance between the pressure of the fluid in the one direction and the pressure of the fluid in the other direction, the flow of the fluid from the one direction to the other direction is controlled while the flow of the fluid from the other direction to the one direction is controlled.

(B) In the above embodiments, the relief passage extends along the central axis of the first discharge valve body, and the discharge passages are placed on the radially outer side of the relief passage. However, the relationship between the location of the relief passage and the location of the discharge passages is not limited to this one.

(C) In the above embodiments, the number of discharge passages is four. Also, the single relief passage is formed. However, the number of the discharge passage(s) and the number of the relief passage(s) are not limited to the above ones. That is, the number of the discharge passage(s) may be set to any desirable number, and the number of the relief passage(s) may be set to any desirable number. Here, it is only required to provide at least one discharge passage and at least one relief passage.

(D) In the above embodiments, the cross-sectional area (total cross-sectional area) of the relief passage is set to be smaller than the total cross-sectional area of the discharge passages. However, the relationship between the cross-sectional area of the relief passage(s) and the cross-sectional area of the discharge passage(s) is not limited to this one. That is, the total cross-sectional area of the relief passage(s) may be set to be larger than the total cross-sectional area of the discharge passage(s).

As discussed above, the present disclosure is not limited to the above embodiments, and the above embodiments may be modified within the principle of the present disclosure.

What is claimed is:

1. A valve apparatus comprising:
a valve housing;
a first valve element that is reciprocatably received in one end portion of the valve housing;
a first urging device that urges the first valve element toward another end portion of the valve housing, which is opposite from the one end portion of the valve housing;
a second valve element that is reciprocatably received in the another end portion of the valve housing;
a second urging device that urges the second valve element toward the one end portion of the valve housing; and
a common seat portion that divides an inside of the valve housing into a first valve chamber, which receives the first valve element, and a second valve chamber, which receives the second valve element, wherein:
the first valve element and the second valve element are seatable against and liftable away from the common seat portion; and
the common seat portion includes:
at least one first communication passage that communicates between the first valve chamber and the second valve chamber when the second valve element is lifted away from the common seat portion; and
at least one second communication passage that extends substantially parallel to the at least one first communication passage and communicates between the first valve chamber and the second valve chamber when the first valve element is lifted away from the common seat portion.

2. The valve apparatus according to claim 1, wherein:
the second valve element is lifted away from the common seat portion when a product of a total cross-sectional area of the at least one first communication passage and a pressure of the first valve chamber is larger than a sum of:
an urging force of the second urging device; and
a product of a pressure of the second valve chamber and a pressure receiving surface area of the second valve element, which receives the pressure of the second valve chamber; and
the first valve element is lifted away from the common seat portion when a product of the pressure of the second valve chamber and a total cross-sectional area of the at least one second communication passage is larger than a sum of:
an urging force of the first urging device; and
a product of the pressure of the first valve chamber and a pressure receiving surface area of the first valve element, which receives the pressure of the first valve chamber.

3. The valve apparatus according to claim 1, wherein the at least one first communication passage is placed on a radially outer side of the at least one second communication passage.

4. The valve apparatus according to claim 1, wherein the at least one second communication passage extends along a central axis of the common seat portion.

5. The valve apparatus according to claim 1, wherein a total cross-sectional area of the at least one first communication passage is larger than a total cross-sectional area of the at least one second communication passage.

6. The valve apparatus according to claim 1, wherein the at least one first communication passage includes a plurality of first communication passages.

7. The valve apparatus according to claim 6, wherein the plurality of first communication passages is arranged one after another at generally equal intervals along a circle, which is coaxial with a central axis of the common seat portion.

8. The valve apparatus according to claim 1, wherein a first projection, which is contactable with the second valve element, is formed in a peripheral edge part, which forms an opening of the at least one first communication passage located on the second valve chamber side.

9. The valve apparatus according to claim 8, wherein the first projection is formed continuously to surround the opening of the at least one first communication passage located on the second valve chamber side.

10. The valve apparatus according to claim 1, wherein a second projection, which is contactable with the common seat portion, is formed in a seat surface of the second valve element located on the common seat portion side.

11. The valve apparatus according to claim 10, wherein the second valve element is formed through press forming of a planar plate member.

12. The valve apparatus according to claim 1, wherein the second valve element has a guide portion, which guides one end of the second urging device.

13. The valve apparatus according to claim 1, wherein:
an inner diameter of the second valve chamber is larger than an outer diameter of the second valve element; and
a gap, which conducts fuel, is formed between an inner wall of the second valve chamber and a radially outer wall of the second valve element.

14. The valve apparatus according to claim 13, wherein a third projection, which contacts the radially outer wall of the second valve element, is formed in the inner wall of the second valve chamber.

15. A high pressure pump comprising:
a plunger;
a main body portion that is configured into a cup form and reciprocatably supports the plunger, wherein the main body portion includes a pressurizing chamber, which has a variable volume that changes when the plunger is moved;
a fuel supply arrangement that supplies fuel to the pressurizing chamber; and
a fuel discharge arrangement that includes the valve apparatus of claim 1 and discharges the fuel of the pressurizing chamber to an outside of the high pressure pump.
